(19) United States
(12) Patent Application Publication
(10) Pub. No.: US 2026/0054390 A1
(43) Pub. Date: Feb. 26, 2026

(54) METHODS FOR TELEOPERATION OF WHOLE-BODY MANIPULATION

(71) Applicant: Toyota Research Institute, Inc., Los Altos, CA (US)

(72) Inventors: Jose A. Barreiros, Los Altos, CA (US); Aykut O. Onol, Los Altos, CA (US); Mengchao Zhang, Los Altos, CA (US); Samson Creasey, Los Altos, CA (US); Aimee Goncalves, Los Altos, CA (US); Andrew Beaulieu, Los Altos, CA (US); Katherine M. Tsui, Los Altos, CA (US); Alexander Alspach, Los Altos, CA (US); Russell L. Tedrake, Los Altos, CA (US); Aditya Bhat, Los Altos, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 19/305,875

(22) Filed: Aug. 21, 2025

Related U.S. Application Data
(60) Provisional application No. 63/685,881, filed on Aug. 22, 2024.

(51) Int. Cl. B25J 9/16

(52) U.S. Cl. CPC B25J 9/1689; B25J 9/163

(57) ABSTRACT

A method may comprise receiving one or more primitives associated with a robot, each of the one or more primitives comprising a plurality of joints of the robot that move together; while a user teleoperates the robot to perform a task of manipulating an object, receiving robot configuration data associated with the robot, object configuration data associated with the object, and position commands input by the user based on the one or more primitives as training data; perturbing the training data; performing domain randomization on the training data; and learning a policy for controlling the robot to autonomously perform the task based on the training data.

### CROSS-REFERENCE TO RELATED APPLICATION

The present specification is based on, and claims the benefit of, U.S. Provisional Application No. 63/685,881, filed Aug. 22, 2024, the disclosure of which is hereby incorporated by reference in its entirety.

### TECHNICAL FIELD

The present specification relates to robot learning, and more particularly to methods for teleoperation of whole-body manipulation.

### BACKGROUND

Humans have the ability to manipulate objects with wide-ranging sizes and shapes by leveraging the dexterity of hands, full-body engagement, and interactions with the environment (e.g., bracing). The taxonomy of human dexterity includes both fine and gross manipulation skills. Gross motor skills in humans involve engaging the whole body through the activation of large muscle groups including the arms, trunk, and legs. These skills enable everyday functions for humans such as carrying grocery bags, moving furniture, and carrying heavy objects.

In robotics, it may be desirable to replicate and integrate these dexterous human skills. Model-based planning methods face difficulties when applied to contact-rich problems because contact events lead to stiff and discontinuous numerics with excessive discrete modes, resulting in a non-convex and disconnected search space. Imitation learning requires a considerable amount of expert demonstrations. As such, there is a need for improved methods of training robotics for whole-body manipulation.

### SUMMARY

In one embodiment, a method may include receiving one or more primitives associated with a robot, each of the one or more primitives comprising a plurality of joints of the robot that move together; while a user teleoperates the robot to perform a task of manipulating an object, receiving robot configuration data associated with the robot, object configuration data associated with the object, and position commands input by the user based on the one or more primitives as training data; perturbing the training data; performing domain randomization on the training data; and learning a policy for controlling the robot to autonomously perform the task based on the training data.

In another embodiment, a method may include receiving a task to be performed by a robot comprising manipulation of an object; generating a motion plan to cause the object to perform the task to generate training data; perturbing the training data; performing domain randomization on the training data; and learning a policy for controlling the robot to autonomously perform the task based on the training data.

In another example, a computing device may include one or more processors configured to receive one or more primitives associated with a robot, each of the one or more primitives comprising a plurality of joints of the robot that move together; while a user teleoperates the robot to perform a task of manipulating an object, receive robot configuration data associated with the robot, object configuration data associated with the object, and position commands input by the user based on the one or more primitives as training data; perturb the training data; perform domain randomization on the training data; and learn a policy for controlling the robot to autonomously perform the task based on the training data.

### BRIEF DESCRIPTION OF THE DRAWINGS

The embodiments set forth in the drawings are illustrative and exemplary in nature and are not intended to limit the disclosure. The following detailed description of the illustrative embodiments can be understood when read in conjunction with the following drawings, where like structure is indicated with like reference numerals and in which:

FIG. 1A schematically depicts an example robot for performing an object manipulation task, according to one or more embodiments shown and described herein;

FIG. 1B schematically depicts another view of the example robot of FIG. 1A, according to one or more embodiments shown and described herein;

FIG. 2 depicts an example controller for controlling the robot of FIGS. 1A and 1B, according to one or more embodiments shown and described herein;

FIG. 3 schematically depicts an example computing device for learning contact-rich whole-body manipulation with example-guided reinforcement learning, according to one or more embodiments shown and described herein;

FIG. 4 depicts a flowchart of an example method for operating the computing device of FIG. 3, according to one or more embodiments shown and described herein; and

FIG. 5 depicts a flowchart of another example method for operating the computing device of FIG. 3, according to one or more embodiments shown and described herein.

### DETAILED DESCRIPTION

Embodiments disclosed herein are directed to methods for teleoperation of whole-body manipulation. For structured tasks that are possible to simulate, reinforcement learning has proven to yield remarkable outcomes. Notably, these advancements frequently hinge upon the availability of task-specific insights, either in the form of well-defined reward functions or expert guidance. As a means to streamline the process of reward design, guided reinforcement learning capitalizes on pre-existing knowledge inferred from data to improve the efficiency and efficacy of the reinforcement learning process. In particular, example-guided reinforcement learning aims to combine motion imitation with task-based rewarding and has shown promise in aiding exploration by instilling a desired motion style, thus accelerating learning and easing reward shaping.

In one example, generative adversarial imitation learning (GAIL) effectively integrates a generative adversarial network with reinforcement learning incorporating a discriminator that evaluates the resemblance between the policy and example motions. However, GAIL's direct applicability is limited to cases when the demonstrator's actions are observable.

In another example, adversarial motion prior (AMP) leverages the GAIL framework to discern whether a state transition is a sample from the example motions or one generated by the agent. This approach does not require designing imitation objectives or motion selection mechanisms, and it can automatically synthesize a policy that completes a desired high-level task given a set of example motions and a generic reward function.

Accordingly, in embodiments disclosed herein, a controller based on AMP is integrated with passive and active compliance. The controller uses proprioceptive observations from joint encoders to estimate a state of a robot and exteroceptive observations from tactile sensors to measure binary contact states and from a motion-capture system to estimate an object pose. The resulting control framework enables a robot to perform various whole-body manipulation tasks such as lifting a jug over its shoulder, lifting and reorienting a large box, and flipping a water jug upside down.

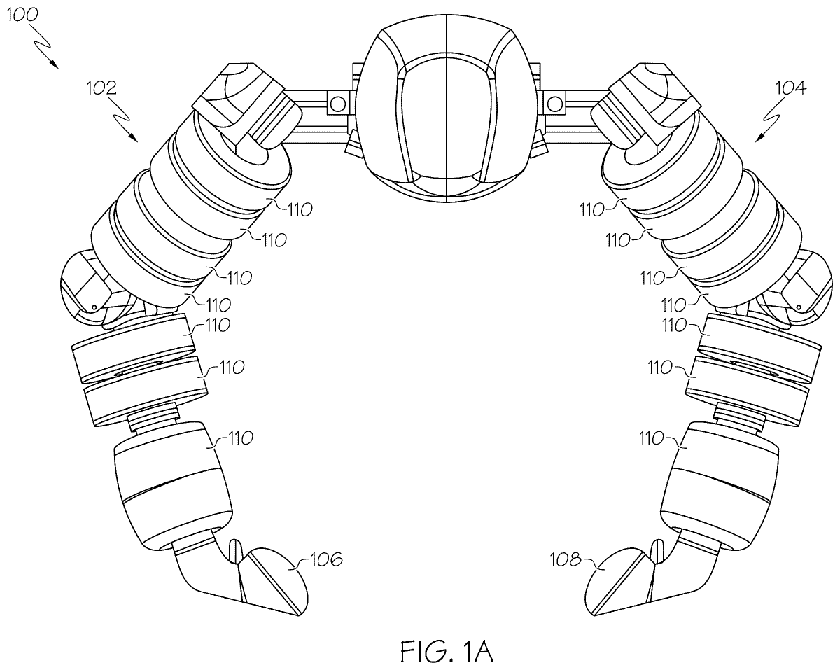

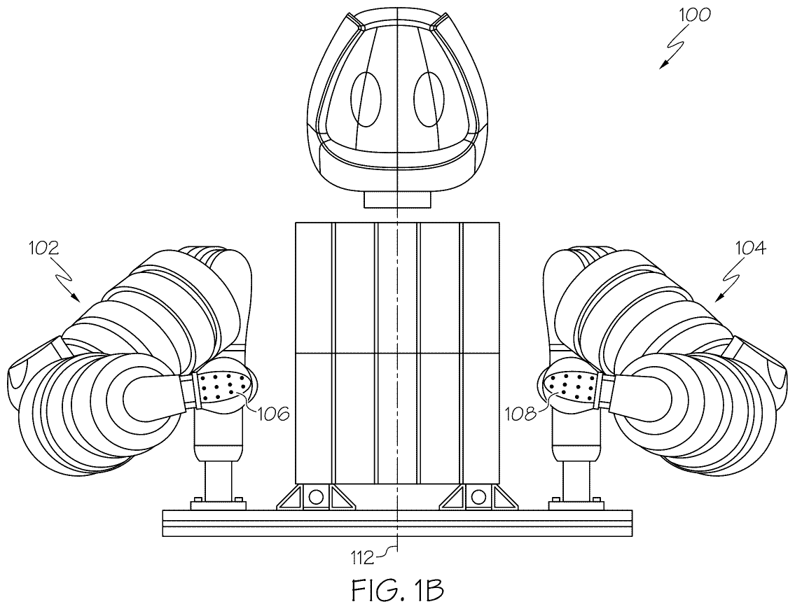

An example robot 100 is shown in FIGS. 1A and 1B. The robot 100 has arms 102 and 104, comprising end effectors 106 and 108, and sensors 110. In the illustrated example, the sensors 110 comprise air-filled compliant contact pressure sensing chambers. However, in other examples, other types of sensors may be used. In the illustrated example, the end effectors 106, 108 are visuotactile and pressure sensing end effectors. The end effectors 106, 108, and the sensors 110 may collect sensor data that may be used to guide operation of the robot 100.

The arms 102, 104 of the robot 100 may perform tasks comprising manipulation of objects. The robot 100 includes a body 112. During operation, the robot 100 may use the body 112 to brace objects or otherwise assist in the manipulation of objects. In some examples, the arms 102, 104, the end effectors 106, 108, the sensors 110, and the body 112 may be covered with a fabric or other compliant material.

In some examples, the robot 100 may be teleoperated by a user to cause the robot 100 to perform a task. Data may be collected from the robot 100 while it is being teleoperated to perform the task. This data may then be used as training data to train the robot to perform the task autonomously. However, for whole-body manipulation, controlling both arms 102, 104 simultaneously presents a significant challenge because of the mapping of the many degrees of freedom of the robot to a limited number of knobs or control elements that a human teleoperator can effectively handle considering the precise timing and coordination that is needed for complex whole-body manipulation. In particular, the arms 102, 104 of the robot 100 may have numerous joints, motors, and other elements that can be individually controlled, and it would be impractical for a human teleoperator to individually control each such element to perform an action.

Accordingly, in embodiments, whole-body motions are broken down into synergies that are combined linearly and controlled via a standard interface, as disclosed herein. In particular, in embodiments disclosed herein, primitives are defined, which comprise groups of joints that always move together. These can be defined by an expert and may be based on human motion. For example, when a human moves one of their arms, certain joints may move together. In the illustrated example, five primitives are defined, namely: enveloping flexion, pinch flexion, torsion, base rotation, and shoulder rotation. Symmetric primitives may be used such that the primitives for the arm 102 are the negative of the primitives for the arm 104. However, it should be understood that in other examples, other primitives may be defined for other types of motions.

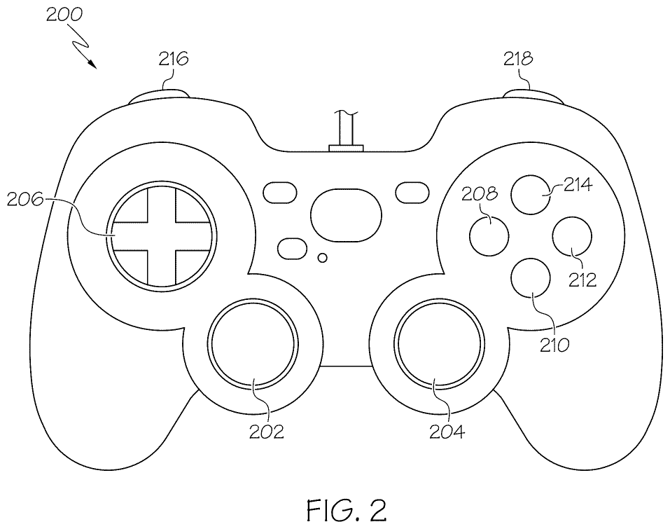

The primitives may be controlled by a user with the use of a controller. In the illustrated example, a Logitech™ F310 controller is used. However, in other examples, other controllers may be used. An example controller 200 is shown in FIG. 2. In the example of FIG. 2, the controller 200 comprises a left thumbstick 202, a right thumbstick 204, arrow buttons 206, an ‘X’ button 208, an ‘A’ button 210, a ‘B’ button 212, a ‘Y’ button 214, a left rear button 216 and a right rear button 218. In the illustrated example, torsion and enveloping flexion for each arm 102, 104 may be controlled by the up/down and left/right motions of the thumbsticks 202, 204, respectively. Shoulder rotation may be activated by the ‘X’ button 208 and the ‘B’ button 212 for the right arm, and by the left and right arrows of the arrow buttons 206 for the left arm. A pinch motion may be obtained by using the left rear button 216 for the left arm and the right rear button 218 for the right arm. However, in other examples, any other arrangement of control inputs of the controller 200 or any other controller may be used to activate each of the defined primitives. In embodiments, the activation for each primitive is a binary scalar, and a joint position command is calculated by integrating the primitive activations over time.

In embodiments, one or more primitives may be defined by an expert. For example, a robot may have a plurality of joints that are operable, and each primitive may define a relationship with each joint. That is, when a particular primitive motion is actuated, the primitive may specify how much each joint should be actuated. In one example, the robot 100 of FIG. 1 may have seven joints that can be actuated (e.g., seven joints in each robot arm 102, 104). In the illustrated example, the five primitives may be defined as follows:

$$Δ {q}_{enveloping flexion} {=}^{Δ} [ 05 , 0 , 0 , - 1.5 , 0 , 0 , 0 ] ,$$

$$Δ {q}_{pinch flexion} {=}^{Δ} [ 0 , 0 , 0 , 0 , 0 , - 1 , 0 ] ,$$

$$Δ {q}_{torsion} {=}^{Δ} [ 0 , - 1 , - 1 , 0 , - 0.5 , 0 , 0 ] ,$$

$$Δ {q}_{base rotation} {=}^{Δ} [ - 0.5 , 0 , 0 , 0 , 0 , 0 , 0 ] ,$$

$$Δ {q}_{shoulder rotation} {=}^{Δ} [ 0 , 0 , - 1 , 0 , 0 , 0 , 0 ]$$

where each value in the above arrays represents one joint in each robot arm 102, 104. For example, when the enveloping flexion primate is actuated by a certain amount, the first joint in each robot arm 102, 104 is actuated by 0.5 times that amount, the second and third joints are not actuated, the fourth joint is actuated by −1.5 times that amount, and the fifth, sixth, and seventh joints are not actuated. However, it should be understood that, in other examples, primitives may be defined in any other manner.

Once a set of primitives are defined, a human teleoperator may perform teleoperation of the robot using the controller 200 to control the defined primitives associated with the robot 100. In particular, the human teleoperator may perform teleoperation of the robot 100 to perform a task (e.g., manipulating an object). This demonstration data may be collected and analyzed. The robot 100 may then be trained to perform the task demonstrated by the human teleoperator as disclosed herein.

In some examples, the human teleoperator controls a simulated robot rather than a physical robot. That is, a software program may simulate operation of the robot 100, and commands input to the controller 200 may be transmitted to this software program. The software program may then cause the simulated robot to move according to the received commands.

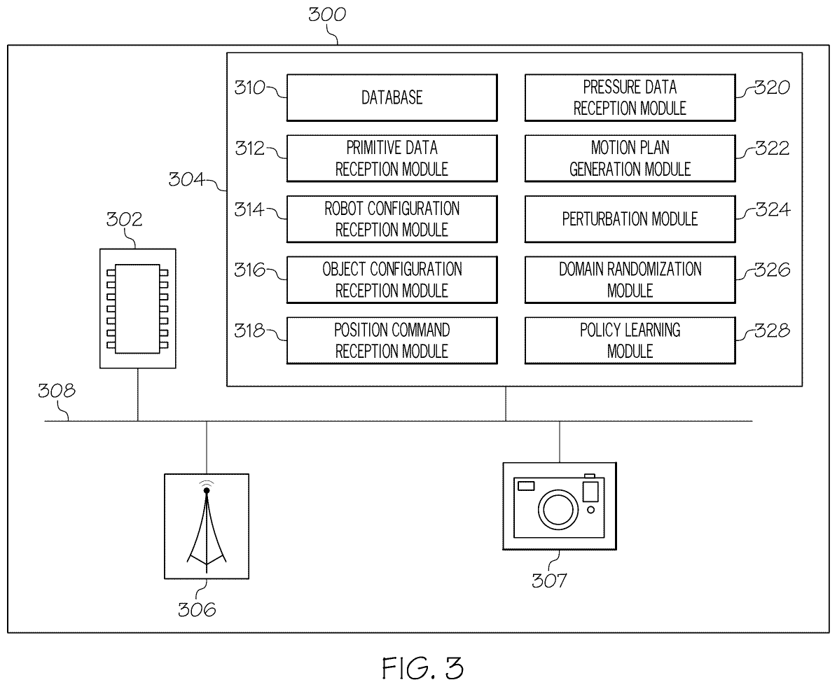

FIG. 3 schematically depicts a computing device 300 for learning contact-rich whole-body manipulation with example-guided reinforcement learning. The computing device 300 of FIG. 3 may comprise a local computing device, a cloud computing device, a dedicated hardware device, or any suitable device capable of performing the functions described herein.

In the example of FIG. 3, the computing device 300 comprises one or more processors 302, one or more memory modules 304, network interface hardware 306, a camera 307, and a communication path 308. The one or more processors 302 may be a controller, an integrated circuit, a microchip, a computer, or any other computing device. The one or more memory modules 304 may comprise RAM, ROM, flash memories, hard drives, or any device capable of storing machine readable and executable instructions such that the machine readable and executable instructions can be accessed by the one or more processors 302.

The network interface hardware 306 can be communicatively coupled to the communication path 308 and can be any device capable of transmitting and/or receiving data via a network. Accordingly, the network interface hardware 306 can include a communication transceiver for sending and/or receiving any wired or wireless communication. For example, the network interface hardware 306 may include an antenna, a modem, LAN port, Wi-Fi card, WiMax card, mobile communications hardware, near-field communication hardware, satellite communication hardware, and/or any wired or wireless hardware for communicating with other networks and/or devices. In one embodiment, the network interface hardware 306 includes hardware configured to operate in accordance with the Bluetooth® wireless communication protocol. The network interface hardware 306 of the computing device 300 may transmit and receive data to and from other devices. In particular, in embodiments disclosed herein, the network interface hardware 306 may receive data from the robot 100 and/or from the controller 200, as disclosed herein.

The camera 307 may capture images of an object being manipulated by the robot 100, as discussed in further detail below. The images of the object captured by the camera 307 may be used by the computing device 300 to determine data about the object, as disclosed herein. The camera 307 may comprise a variety of camera types. In some examples, a plurality of markers are placed on the object being manipulated, and the camera 307 comprises a motion capture device which detects the positions of the markers. The position and orientation of the markers may be determined based on the positions of the detected markers.

The one or more memory modules 304 include a database 310, a primitive data reception module 312, a robot configuration reception module 314, an object configuration reception module 316, a position command reception module 318, a pressure data reception module 320, a motion plan generation module 322, a perturbation module 324, a domain randomization module 326, and a policy learning module 328. Each of the database 310, the primitive data reception module 312, the robot configuration reception module 314, the object configuration reception module 316, the position command reception module 318, the pressure data reception module 320, the motion plan generation module 322, the perturbation module 324, the domain randomization module 326, and the policy learning module 328 may be a program module in the form of operating systems, application program modules, and other program modules stored in the one or more memory modules 304. In some embodiments, the program module may be stored in a remote storage device that may communicate with the computing device 300. Such a program module may include, but is not limited to, routines, subroutines, programs, objects, components, data structures, and the like for performing specific tasks or executing specific data types as will be described below.

The database 310 may store data received by the computing device 300. For example, the database 310 may store primitive data associated with the robot 100, data received from the robot 100, and policy data, as disclosed herein. The database 310 may also store other data used by the various memory modules 304.

The primitive data reception module 312 may receive primitive data associated with the robot 100, as disclosed herein. As discussed above, whole-body manipulation of the robot 100 may be achieved through the use of primitives. In particular, as discussed above, a primitive may be defined as a coupled relationship of joints of the robot 100. That is, for a given whole-body movement (e.g., pinch flexion), a set of joints of the robot 100 may move together as defined by a primitive. Accordingly, the primitive data reception module 312 may receive data associated with a plurality of primitives assigned for the robot 100.

In the illustrated example, the data associated with each primitive comprises an array of values indicating an amount that each joint of a plurality of joints (e.g., seven joints in the example robot 100) move when a particular primitive, or whole-body motion, is actuated. However, in other examples, primitive data may comprise any other form. After the primitive data reception module 312 receives the primitive data associated with the robot 100, the primitive data may be stored in the database 310. Accordingly, when a control command is input using the controller 200, the primitive data may be used to determine how much each joint of the robot 100 should be actuated.

Referring still to FIG. 3, the robot configuration reception module 314 may receive robot configuration data from the robot 100, as disclosed herein. As discussed above, a human user may utilize the controller 200 to teleoperate the robot 100 to perform a task to manipulate an object. While the task is being performed, data may be collected and used as training data in order to train the robot 100 to perform the task autonomously. In particular, during teleoperation of the robot 100, a variety of data is collected, as disclosed herein, including a configuration

$${q}_{t}^{a}$$

of the robot 100, a configuration

$${q}_{t}^{u}$$

of the object being manipulated by the robot 100 during performance of the task, position commands aₜ issued to the robot 100, and pressure readings pₜ from the end effectors 106, 108 and the sensors 110. In the above notation, the subscript t refers to time, the superscript a refers to actuated (e.g., data with respect to the robot 100), and the superscript u refers to unactuated (e.g., data with respect to the object). The robot configuration data

$${q}_{t}^{a}$$

may be received by the robot configuration reception module 314, as disclosed herein. The other data points are discussed in further detail below.

The robot configuration data

$${q}_{t}^{a}$$

may indicate a status of the robot 100. In particular, while the robot 100 is being teleoperated, the robot 100 may continually transmit data indicating the position of the various joints of the robot 100 to the computing device 300. For example, the robot 100 may contain various sensors that record the positions of its various joints. The robot 100 may then transmit the data recorded by these sensors to the computing device 300 every predetermined time interval (e.g., every 0.1 seconds). This data may be received by the robot configuration reception module 314. The data may be used to train the robot 100, as discussed in further detail below.

Referring still to FIG. 3, the object configuration reception module 316 may receive object configuration data, as disclosed herein. As discussed above, in addition to the robot configuration data

$${q}_{t}^{a} ,$$

the computing device 300 also receives object configuration data

$${q}_{t}^{u} .$$

In particular, the camera 307 may continually capture images or other data associated with the object being manipulated (e.g., positions of markers placed on the object) by the robot and this data may be received by the object configuration reception module 316. Upon receiving this data, the object configuration reception module 316 may determine the position and orientation of the object. As such, the object configuration reception module 316 may continually receive the object configuration data

$${q}_{t}^{u} .$$

Referring still to FIG. 3, the position command reception module 318 may receive position commands aₜ issued to the robot 100, as disclosed herein. As discussed, during teleoperation, a user utilizes the controller 200 to control the robot 100. In particular, the user utilizes the controller 200 to enter commands to control predefined primitives associated with the robot 100. These commands are then sent to the robot 100, and various joints of the robot 100 are actuated based on the received commands and the predefined primitives. As such, in embodiments, the robot 100 may transmit commands it receives from the controller 200 to the computing device 300. These commands may be received by the position command reception module 318. In some examples, the position command reception module 318 may receive commands input by the user directly from the controller 200 rather than from the robot 100.

Referring still to FIG. 3, the pressure data reception module 320 may receive pressure readings pₜ from the end effectors 106, 108 and the sensors 110. As discussed above, the end effectors 106, 108 and the sensors 110 may comprise pressure sensors that can detect contact and an amount of force applied to the sensors. Accordingly, these sensors are able to detect when an object is held by the end effectors 106, 108 or when an object is pressed against various parts of the body 112 of the robot 100. This pressure data may be transmitted to the computing device 300, where it is received by the pressure data reception module 320. The received pressure data may be used along with the other received data to train the robot to learn a policy to perform the task being demonstrated by the user, as discussed in further detail below.

In particular, in some examples, there may exist real-world scenarios in which information such as object pose is not directly available. In these examples, the computing device 300 may rely on sensor data received by the pressure data reception module 320 to infer the object pose. In particular, asymmetric actor-critic learning may be implemented where the actor observes a subset of the critic's observations. This may leverage privileged information that is readily available in simulation while training and to rely solely on easy-to-access information, such as pressure data, during inference.

Referring still to FIG. 3, the motion plan generation module 322 may generate motion plan data, as disclosed herein. As discussed above, in one embodiment, the robot 100 may be teleoperated by a human using the controller 200 to cause the robot 100 to perform an object manipulation task. The movement of the robot 100 and the object being manipulated, along with the control commands entered into the controller 200, may be received by the computing device 300 and used as training data to train the robot 100 to autonomously perform the task, as discussed in further detail below. However, in another embodiment, example motions of the robot 100 may be obtained through motion planning, as disclosed herein.

In this embodiment, the motion plan generation module 322 may generate a motion plan for the robot 100 to perform a specified task. This motion plan may be used to train the robot 100 to perform the task, as discussed in further detail below. In some examples, the motion plan generation module 322 utilizes Global Quasi-Dynamic Planner (GQDP) to determine motion plans. These examples assume quasi-dynamic mechanics to reduce the problem into the configuration space, and a contact smoothing scheme is used along with a locally linearized model to derive a reachability metric. As a result, the problem of planning through contact, given initial and desired configurations of the object, can be effectively addressed using a sampling-based planner. In the illustrated example, the motion plan generation module 322 uses Rapidly-Exploring Random Tree (RRT) to generate a motion plan, as disclosed herein.

In embodiments disclosed herein, the motion plan generation module 322 may generate a motion plan (e.g., a coarse path) for the robot 100 to perform a specified object manipulation task using RRT (e.g., a task specified by a user). The motion plan generation module 322 may then refine the coarse path generated by RRT using trajectory optimization to output a trajectory denoted as

$${τ}^{′} = \{ ( {q}_{t}^{a} , {q}_{t}^{u} , {q}_{cmd , t}^{a} ) \vert t = 0 , … , T \} .$$

This refinement step eliminates non-physical artifacts caused by contact smoothing and large time steps used for the search, as well as improving the path that may be non-smooth due to the random nature of RRT. In this example,

$${q}_{t}^{a} and {q}_{t}^{u}$$

represent the configuration of the actuated and unactuated degrees of freedom of the system corresponding to the robot 100 and the object being manipulated, respectively. In this example,

$${q}_{cmd , t}^{a}$$

denotes the robot positon commands for a joint stiffness controller at each time step t.

Utilizing motion planning to generate training examples may produce complex motions that can be challenging to achieve through teleoperation. However, teleoperation may allow for training examples to be generated more quickly when done by a trained operator. As such, both teleoperation and motion planning may be useful in different situations.

Referring still to FIG. 3, the perturbation module 324 may perturb training data robot motions generated either by teleoperation or by motion planning, as disclosed herein. Perturbing the robot motion of training data may emulate scenarios of noisy sensor readings and/or signal loss. This may allow for the most robust training of the robot 100. In embodiments, the perturbation module 324 may perturb the robot 100's configuration

$${q}_{t}^{a}$$

in the example motion in two ways. First, the perturbation module 324 may inject noise sampled from a Gaussian distribution with zero mean and varying standard deviation. For example, the perturbation module 324 may inject Gaussian noise having a standard deviation of 0.01 rad, 0.1 rad, 0.5 rad, or other values. Second, the perturbation module 324 may discard intermediate configurations along a trajectory, retaining only every k^{th} waypoints, and performing linear interpolation for the intervening time steps. For example, the perturbation module 324 may retain every 10^{th} waypoint, every 20^{th} waypoint, every 50^{th} waypoint, or waypoints of other intervals. These perturbed motions may then be used to train the robot 100. Using these perturbed motions for training the robot 100 may improve the training process.

Referring still to FIG. 3, the domain randomization module 326 may modify object parameters during training, as disclosed herein. In particular, a disturbance sampled from a distribution may be applied to the nominal value of each randomization parameter. These parameters may include the mass, friction, scale, and initial position and yaw associated with the object being manipulated. The parameters may also include friction, joint stiffness, joint damping, and action associated with the robot. In other examples, other parameters may be associated with domain randomization. Domain randomization may improve training and allow for a policy to be easily transferred to hardware.

Referring still to FIG. 3, the policy learning module 328 may learn a policy for performing the action, as disclosed herein. In embodiments, as discussed above, the computing device 300 receives robot configuration data, objection configuration data, and position commands issued to the robot while the robot 100 is being controlled to perform a task. In some examples, the computing device 300 may also receive pressure data. This received data may be used by the policy learning module 328 to learn a policy for the robot 100 to autonomously perform the task.

In embodiments, the policy learning module 328 utilizes example-guided reinforcement learning (EGRL) to learn a policy for performing the task. Given a dataset of example motions and a task objective defined by a reward function, EGRL synthesizes a control policy that enables the robot 100 to achieve the specified task objective while adopting behaviors that mimic the style of the example motion dataset. In embodiments, the example motion dataset may be based on teleoperation of the robot 100, or a motion plan generated by the motion plan generation module 322, as described above. The objective of EGRL is to train a policy, π, capable of completing a desired manipulation task while adhering to the motion style defined in the example motions dataset. In the illustrated example, only one example motion is utilized. For this purpose, the policy learning module 328 trains the policy along with a discriminator. The discriminator is designed to learn an imitation reward such that the agent uses the demonstrated motion style while simultaneously learning how to accomplish the task.

In manipulation, a motion style can be considered a particular sequence of states by which a manipulation task is performed. Assume in an example motion, the system experiences a sequence of states, denoted as Tₑₓₐₘₚₗₑ=[sq, s2, . . . , sn]. Given a control policy π, which at each time step t, perceives the state sₜ∈S of the system and samples an action aₜ∈A (e.g., change of joint positions of the robot 100), adhering to the probabilistic distribution aₜ˜π(aₜ|sₜ)/ Then, starting from the same initial state s₁ and following the actions produced by the policy, the system will experience a sequence of states, denoted

$${T}_{π} = [ {s}_{1} , {s}_{2}^{′} , … , {s}_{n}^{′} ] .$$

The state transitions (sₜ, sₜ₊₁) from both Tₑₓₐₘₚₗₑ and T_{π} can be viewed as samples from two different distributions Dₑₓₐₘₚₗₑ and D_{π}. Then, the style imitations can be achieved by seeking a policy π that can minimize the difference between the distributions Dₑₓₐₘₚₗₑ and D_{π}.

In embodiments, the policy is modeled as a neural network that maps a given state to a Gaussian distribution over actions. This distribution features a mean dependent on the input and a fixed diagonal covariance matrix. The mean is determined by a fully connected network with hidden layers and a linear output layer.

In embodiments, the agent receives a scalar reward rₜ=r(sₜ, aₜ, sₜ₊₁) after executing the action aₜ produced by the policy at time t. The reward function may be formulated as a weighted average of two distinct components: (I) the task reward r^{T} that quantifies the degree of task accomplishment, and (ii) the style reward r^{S} that assesses the resemblance between the robot's motion and the example motion: r(sₜ, aₜ, sₜ₊₁)=λr^{T}(s_{t+′}, aₜ)+(1−λ)r^{S}(sₜ, sₜ₊₁), where λ∈[0,1] determines the task reward weight with respect to the imitation reward weight. Obtaining the ideal behavior for a specific task may require tuning. A λ too large could result in the robot focusing only on finishing the task without respecting the motion style, whereas a λ too small could cause the robot to focus only on mimicking the motion style without accomplishing the task. The policy learning module 328 chooses the ideal by running a parameter sweep over a grid of values for each task. The behaviors are not very sensitive to this parameter, and in the illustrated example, a value of λ=0.7 is chosen for all the tasks. However, in other examples, other values of λ may be used.

In embodiments, to minimize reward shaping, a simple and generic task reward function r^{T}=dₖₚ+p is chosen where dₖₚ depends on the distance between a set of keypoints on the object being manipulated and their corresponding positions when the object is in the goal pose, and p encompasses conventional penalty components often adopted for reinforcement learning, such as penalties for actions and velocities, early termination, and a success bonus.

In the illustrated example, the detailed task reward is defined as

$${r}_{t}^{T} = {ω}_{k p} ( 1 / ( ‖ {d}_{k p} ( {q}_{t}^{u} , {q}_{g}^{u} ) ‖ + 0. 1 ) ) + {ω}_{a} {‖ {a}_{t} ‖}^{2} + {ω}_{d a} {‖ Δ {a}_{t} ‖}^{2} + {ω}_{τ} {‖ {τ}_{t} ‖}^{2} + {ω}_{l i n} {‖ {q}_{t , lin}^{u} ‖}^{2} + {ω}_{rot} {‖ {\dot{q}}_{t , rot}^{u} ‖}^{2} + {ω}_{term} {1}_{term} ( {q}_{t}^{u} ) + {ω}_{succ} {1}_{succ} ( {\dot{q}}_{t}^{u} , {\dot{q}}_{t}^{u} ) .$$

The first term incentivizes task completion by penalizing the distance of the keypoints from their desired positions. The following terms impose penalties on the squared L2 norms of the actions of the robot actions, aₜ, the change of actions, Δaₜ≙aₜ−aₜ₋₁, joint torques, τₜ, and the object's translational and rotational velocities,

$${\dot{q}}_{t , lin}^{u} and {\dot{q}}_{t , rot}^{u} .$$

The final two terms impose a penalty upon the activation of termination conditions and a bonus upon the completion of success criteria. The functions 1ₜₑᵣₘ(·) and 1_{succ}(·) are activation functions based on termination and success conditions. The termination conditions are triggered if the object goes out of the workspace limits, while the success criteria are based on the deviation of the object pose from the goal and the linear and angular object velocity terms. The same weights, ω∈ [symbol] , may be used across tasks.

The style reward r^{S} may be decided by the discriminator D, which discriminates whether a state transition belongs to the example motion distribution or not. It is trained together with the policy from scratch, and the discriminator learns to assign a score of 1 to samples from the example motion dataset and 0 to samples in the policy's rollout buffer. This may be trained by solving the least-squares regression problem with loss defined as: L= [symbol] _{(s,s′)˜M}[D(ϕ(s), ϕ(s′)−1²)]+ [symbol] _{(s,s′)˜B}[D(ϕ(s), ϕ(s′)−1²)]+ω_{gp} [symbol] _{(s,s′)˜M} [(D(ϕ(s)), ϕ(s′)−1²)], where ϕ(·) extracts desired imitation features from the system state s, and the final term is a gradient penalty term with coefficient ω_{gp}, which penalizes non-zero gradients on samples from the example motions, resulting in improved stability of the training. At each time step during training, the latest state transition is used to calculate the style reward r^{S}, which is defined as:

$${r}^{S} = - log ( 1 - \frac{1}{1 + {e}^{- D ( ϕ ( s ) , ϕ ( {s}^{′} ) )}} ) .$$

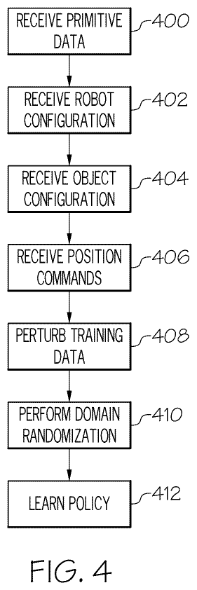

FIG. 4 depicts a flowchart of an example method of operating the computing device 300 to train the robot 100 to autonomously perform an object manipulation task. In particular, the example of FIG. 4 illustrates a method of training the robot 100 to perform a task via teleoperation.

At step 400, the primitive data reception module 312 receives primitive data associated with the robot 100. As discussed above, the primitive data received by the primitive data reception module 312 indicates relationships between joints of the robot 100 that always move together.

At step 402, the robot configuration reception module 314 receives robot configuration data while a user is controlling the robot 100 to perform a particular task. As discussed above, the user may utilize a controller (e.g., the controller 200 of FIG. 2) to cause the robot 100 to perform whole-body motions defined by primitives. While this is being done, the robot configuration reception module 314 may continually receive robot configuration data indicating positions of the various joints of the robot 100.

At step 404, the object configuration reception module 316 receives object configuration data associated with the object being manipulated by the robot 100. In particular, as discussed above, while the object is being manipulated by the robot 100, the object configuration reception module 316 may continually receive object configuration data indicating a position and orientation of the object.

At step 406, the position command reception module 318 receives position commands input by the user. In particular, as discussed above, the position command reception module 318 may receive control commands input by the user (e.g., with the controller 200 of FIG. 2) to control the robot to perform the manipulation task. The received robot configuration data, object configuration data, and position commands may be used as training data to learn the policy for controlling the robot 100 to perform the task.

At step 408, the perturbation module 324 perturbs the training data received by the computing device 300, as discussed above. At step 410, the domain randomization module 326 performs domain randomization to modify parameters of the training data including positions associated with the robot 100 and/or the object being manipulated. At step 412, the policy learning module 328 learns a policy for controlling the robot 100 to autonomously perform the object manipulation task based on the received training data.

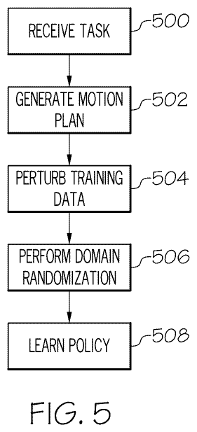

FIG. 5 depicts a flowchart of another example method of operating the computing device 300 to train the robot 100 to autonomously perform an object manipulation task. In particular, the example of FIG. 5 illustrates a method of training the robot 100 to perform a task based on motion planning.

At step 500, the motion plan generation module 322 receives an object manipulation task to be performed by the robot 100. At step 502, the motion plan generation module 322 generates a motion plan for the robot 100 to perform the received manipulation tasks. As discussed above, the motion plan generation module 322 may utilize GQDP or, more specifically, RRT to generate the motion plan. The generated motion plan may be used as training data for learning the policy to control the robot 100 to perform the object manipulation task.

At step 504, the perturbation module 324 perturbs the training data received by the computing device 300, as discussed above. At step 506, the domain randomization module 326 performs domain randomization to modify parameters of the training data including positions associated with the robot 100 and/or the object being manipulated. At step 508, the policy learning module 328 learns a policy for controlling the robot 100 to autonomously perform the object manipulation task based on the training data.

It should now be understood that embodiments described herein are directed to methods for teleoperation of whole-body manipulation. Whole-body manipulation of a robot can be difficult to simulate or for a user to teleoperate. As such, defining primitives relating movement of multiple joints of a robot together can allow for a user to more easily control the robot to perform a task during teleoperation. Data collected during teleoperation of the robot performing the task can then be used to learn a policy for autonomous performance of the task by the robot. In particular, example-guided reinforcement learning can be used with the training data to effectively learn a policy for controlling the robot to perform the task.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving one or more primitives associated with a robot, each of the one or more primitives comprising a plurality of joints of the robot that move together;
while a user teleoperates the robot to perform a task of manipulating an object, receiving robot configuration data associated with the robot, object configuration data associated with the object, and position commands input by the user based on the one or more primitives as training data;
perturbing the training data;
performing domain randomization on the training data; and
learning a policy for controlling the robot to autonomously perform the task based on the training data.

2. The method of claim 1, wherein the robot configuration data comprises positions of joints of the robot while the task is being performed.

3. The method of claim 1, wherein the object configuration data comprises a position and orientation of the object while the task is being performed.

4. The method of claim 1, further comprising:
receiving pressure data from one or more pressure sensors associated with the robot while the task is being performed; and
learning the policy based at least in part on the pressure data.

5. The method of claim 1, further comprising:
receiving image data of the object while the task is being performed; and
determining the object configuration data based on the image data.

6. The method of claim 1, wherein the user teleoperates a simulation of the robot.

7. The method of claim 1, further comprising perturbing the training data by injecting noise sampled from a Gaussian distribution.

8. The method of claim 1, further comprising perturbing the training data by discarding intermediate configurations of the training data.

9. The method of claim 1, further comprising performing the domain randomization by applying a disturbance to one or more parameters associated with the robot configuration data and/or the object configuration data.

10. The method of claim 1, further comprising learning the policy using example-guided reinforcement learning.

11. A method comprising:
receiving a task to be performed by a robot comprising manipulation of an object;
generating a motion plan to cause the object to perform the task to generate training data;
perturbing the training data;
performing domain randomization on the training data; and
learning a policy for controlling the robot to autonomously perform the task based on the training data.

12. The method of claim 11, further comprising generating the motion plan using a Global Quasi-Dynamic Planner.

13. The method of claim 11, further comprising generating the motion plan using Rapidly-Exploring Random Tree.

14. The method of claim 11, further comprising perturbing the training data by injecting noise sampled from a Gaussian distribution.

15. The method of claim 11, further comprising perturbing the training data by discarding intermediate configurations of the training data.

16. The method of claim 11, further comprising performing the domain randomization by applying a disturbance to one or more parameters associated with the motion plan.

17. The method of claim 11, further comprising learning the policy using example-guided reinforcement learning.

18. A computing device comprising one or more processors configured to:
receive one or more primitives associated with a robot, each of the one or more primitives comprising a plurality of joints of the robot that move together;
while a user teleoperates the robot to perform a task of manipulating an object, receive robot configuration data associated with the robot, object configuration data associated with the object, and position commands input by the user based on the one or more primitives as training data;
perturb the training data;
perform domain randomization on the training data; and
learn a policy for controlling the robot to autonomously perform the task based on the training data.

19. The computing device of claim 18, wherein the one or more processors are further configured to perturb the training data by injecting noise sampled from a Gaussian distribution.

20. The computing device of claim 18, wherein the one or more processors are further configured to perturb the training data by discarding intermediate configurations of the training data.
